(19) United States
(12) Patent Application Publication
(10) Pub. No.: US 2007/0161491 A1
(43) Pub. Date: Jul. 12, 2007

(54) Centrifuging settling tube and organic cell collection tube

(75) Inventors: Masao Jinno, Kawasaki-shi (JP); Futoshi Inoue, Shizuoka (JP)

Correspondence Address: BUCHANAN, INGERSOLL & ROONEY PC, POST OFFICE BOX 1404, ALEXANDRIA, VA, 22313-1404, US

(73) Assignee: KABUSHIKI KAISHA KITAZATO SUPPLY, Fujinomiya-shi (JP)

(21) Appl. No.: 10/573,991

(22) PCT Filed: Sep. 29, 2004
(86) PCT No.: PCT/JP04/14707

§ 371 Date: Sep. 29, 2006

(30) Foreign Application Priority Data
Sep. 30, 2003 (JP) 2003-340495

(51) Int. Cl. B04B 5/02

(52) U.S. Cl. 494/16

(57) ABSTRACT

A centrifugal settling tube (1) including a bottomed tube (2), an inner tube (3) constituted of a tube body (31) that is insertable into the bottomed tube (2) and open at distal and proximal ends thereof and of a ring-like elastic member (32) provided on an outer surface of the distal portion of the tube body (31), a sealing member (4) capable of sealing a rear end opening of the inner tube (3), and a fixing member (5) for removably fixing the inner tube (3) to the bottomed tube (2). A distal end of the inner tube (3) is spaced at a predetermined interval from a distal end of the bottomed tube (2), with the inner tube (3) inserted in the bottomed tube (2). At least during centrifugal separation, the ring-like elastic member (32) is capable of liquid-tightly holding a space between an inner surface of the bottomed tube (2) and the outer surface of the distal portion of the tube body (31). The settling tube (1) further includes a collecting portion (6) formed in a space formed by a surface of a distal end of the ring-like elastic member (32), an inner surface of a distal portion of the bottomed tube (2), and an outer surface of a distal portion of the inner tube (3).

### TECHNICAL FIELD

The present invention relates to a centrifuging settling tube used to separate a mixed solution which can be centrifugally separated into not less than two liquid phases, based on the difference between specific gravities thereof.

### BACKGROUND OF THE INVENTION

HIV infectious disease is still increasing nowadays. Although the treatment therefore has progressed, the HIV infectious disease cannot be cured completely. To completely eradicate infection when a husband has a positive reaction for the HIV and a wife has a negative reaction for the HIV, it is necessary to use a condom to prevent the wife from being infected with the HIV and prevent a vertical transmission. Thereby they cannot have a child. But, many husbands and wives having the HIV desire to have the child. Attempts of performing external fertilization or artificial insemination by using cleaned spermatozoa from which the HIV has been removed are successfully made to allow them to have the child without the wife and the child being infected with the HIV.

Such being the case, the present inventors have studied a centrifugal settling tube to collect a spermatozoa-containing liquid not substantially containing the HIV by removing the HIV from semen containing the HIV.

For example, a centrifugal settling tube is disclosed in Japanese Patent Application Laid-Open No. H9-285740 (patent document 1) and Japanese Patent Application Laid-Open No. 2001-46915 (patent document 2) respectively.

In the patent document 1, as shown in a vertical sectional view of FIG. 4 of the patent document 1, the centrifuging settling tube in which the cap 2 liquid-tightly closing the opening formed on the upper surface of the cylindrical bottomed container body 1, which is constructed of the stopper 3, the inner tube 4, and the closing plug 5, is disclosed. The stopper 3 of this centrifuging settling tube is inserted into the upper end of the container body 1 to hermetically seal the peripheral surface thereof, and the through-hole 6 is formed at the central portion thereof. The inner tube 4 is cylindrical and has the outer diameter smaller than the inner diameter of the container body 1. The diameter of the lower part of the inner tube 4 decreases gradually. The upper end of the inner tube 4 is fixed to the inner peripheral portion of the through-hole 6 of the stopper 3 to integrate the upper end of the inner tube 4 with the stopper 3. The length of the inner tube 4 is set to such an extent that the lower end thereof is disposed in the vicinity of the inner side of the bottom surface of the container body 1, when the stopper 3 hermetically seals the upper end of the container body 1. The closing plug 5 is upwardly inserted into the lower-end opening of the inner tube 4 and liquid-tightly closes the lower-end opening of the inner tube 4. The closing plug 5 is removed easily by the downward pressing force, namely, by the pressing force applied thereto downward by the dispensing nozzle or the lower end of a pipette. The centrifugal settling tube disclosed in the patent document 2 has a construction similar to that of the patent document 1.

The present inventors have considered that after a semen-containing liquid not substantially containing the HIV is collected by removing the-HIV from the semen containing the HIV, it is desirable to remove the HIV at a higher level.

However, in the above-described centrifuging settling tube, to collect the liquid disposed in the lower layer, it is necessary to insert the dispensing nozzle or the pipette into the centrifuging settling tube by passing them through the liquid disposed in the upper layer. In this insertion operation, there is a possibility that the substance, for example, the HIV, contained in the upper layer mixes with the liquid disposed in the lower layer.

Therefore it is an object of the present invention to provide a centrifuging settling tube capable of collecting a liquid disposed in a lower layer without the liquid disposed in the lower layer being mixed with a substance contained in a liquid disposed in an upper layer formed by centrifugal separation.

It is another object of the present invention to provide an organic cell collection tube for securely collecting organic cells not mixed with viruses and bacteria from a liquid which contains the organic cells and contains possibly viruses or bacteria mixed therewith.

### DISCLOSURE OF THE INVENTION

The above-described object is achieved by the following centrifuging settling tube.

The centrifuging settling tube of the present invention has a bottomed tube closed at a distal end thereof and open at a proximal end thereof, an inner tube constituted of a tube body that is insertable into the bottomed tube and open at distal end and proximal ends thereof and of a ring-like elastic member provided on an outer surface of the distal portion of the tube body, a sealing member capable of sealing a rear end opening of the inner tube, and a fixing member for removably fixing the inner tube to the bottomed tube. The distal end of the inner tube is spaced at a predetermined interval from a distal end of the bottomed tube, with the inner tube inserted into the bottomed tube. At least during centrifugal separation, the ring-like elastic member is capable of liquid-tightly holding a space between an inner surface of the bottomed tube and the outer surface of the distal portion of the tube body. The settling tube further includes a collecting portion formed in a space formed by a surface of a distal end of the ring-like elastic member, an inner surface of a distal portion of the bottomed tube, and an outer surface of a distal portion of the inner tube.

The above-described object is achieved by the following organic cell collection tube.

The organic cell collection tube removes viruses or bacteria from a liquid containing organic cells and collecting the organic cells. The organic cell collection tube has a tube having a path penetrating therethrough from one to other ends thereof, a sealing member layer, accommodated in the tube, which contacts a moisture content and is thereby capable of substantially forming a liquid-tight state, a first aqueous liquid layer which is formed at a position nearer to one end of the tube than the sealing member layer and spaced at a predetermined interval from the sealing member layer, a first air layer provided between the first aqueous liquid layer and the sealing member layer, a second aqueous liquid layer formed at a position spaced at a predetermined interval from the first aqueous liquid layer, a second air layer provided between the second aqueous liquid layer and the first aqueous liquid layer, and a viscous substance-containing liquid layer which is provided in contact with the second aqueous liquid layer and captures viruses or bacteria disposed at one end portion of the tube.

### BRIEF DESCRIPTION OF THE DRAWINGS

FIG. 1 is a front view of one embodiment of the centrifuging settling tube of the present invention.

FIG. 2 is a sectional view of the centrifuging settling tube shown in FIG. 1.

FIG. 3 is a front view of a bottomed tube for use in the centrifuging settling tube shown in FIG. 1.

FIG. 4 is a front view of an inner tube for use in the centrifuging settling tube shown in FIG. 1.

FIG. 5 is a sectional view of a fixing member for use in the centrifuging settling tube shown in FIG. 1.

FIG. 6 is an explanatory view for explaining a centrifuging settling tube according to another embodiment of the present invention.

FIG. 7 is an explanatory view for explaining a centrifuging settling tube according to another embodiment of the present invention.

FIG. 8 is an explanatory view for explaining a centrifuging settling tube according to another embodiment of the present invention.

FIG. 9 is an explanatory view for explaining a centrifuging settling tube according to another embodiment of the present invention.

FIG. 10 is an explanatory view for explaining a centrifuging settling tube according to another embodiment of the present invention.

FIG. 11 is an explanatory view for explaining a centrifuging settling tube according to another embodiment of the present invention.

FIG. 12 is an explanatory view for explaining the method of using the centrifuging settling tube of the present invention.

FIG. 13 is an explanatory view for explaining another method of using the centrifuging settling tube of the present invention.

FIG. 14 is an outlook view of the organic cell collection tube of the present invention on which a suction appliance is mounted.

FIG. 15 is a sectional view of an organic cell collection tube according to one embodiment of the present invention.

FIG. 16 is a sectional view of an organic cell collection tube according to another embodiment of the present invention.

FIG. 17 is a sectional view of an organic cell collection tube according to another embodiment of the present invention.

FIG. 18 is an enlarged sectional view of a proximal portion of a centrifugal settling tube according to another embodiment of the present invention.

FIG. 19 is an enlarged sectional view of a proximal portion of a centrifugal settling tube according to another embodiment of the present invention.

### BEST MODE FOR CARRYING OUT THE INVENTION

The centrifuging settling tube of the present invention will be described below by using the embodiments shown in the drawings.

A centrifugal settling tube 1 of the present invention includes a bottomed tube 2 closed at a distal end thereof and open at a proximal end thereof, an inner tube 3 constituted of a tube body 31 that is insertable into the bottomed tube 2 and open at distal and proximal ends thereof and of a ring-like elastic member 32 provided on an outer surface of the distal portion of the tube body 31, a sealing member 4 capable of sealing a rear end opening of the inner tube 3, and a fixing member 5 for removably fixing the inner tube 3 to the bottomed tube 2. A distal end of the inner tube 3 is spaced at a predetermined interval from a distal end of the bottomed tube 2, with the inner tube 3 inserted in the bottomed tube 2. At least during centrifugal separation, the ring-like elastic member 32 is capable of liquid-tightly holding a space between an inner surface of the bottomed tube 2 and the outer surface of the distal portion of the tube body 31. The settling tube 1 has a collecting portion 6 formed in a space formed by a surface of a distal end of the ring-like elastic member 32, an inner surface of a distal portion of the bottomed tube 2, and an outer surface of a distal portion of the inner tube 3.

The centrifugal settling tube 1 has the bottomed tube 2, the inner tube 3 constituted of the tube body 31 and of the ring-like elastic member 32 provided on the outer surface of the distal portion of the tube body 31, the sealing member 4, and the fixing member 5.

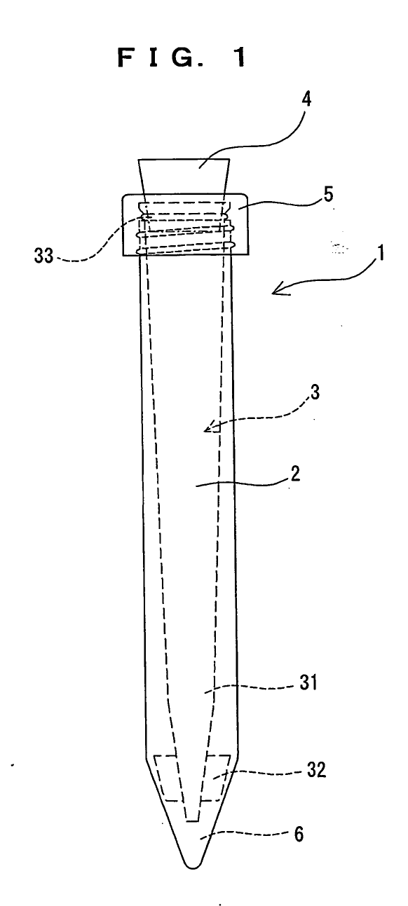

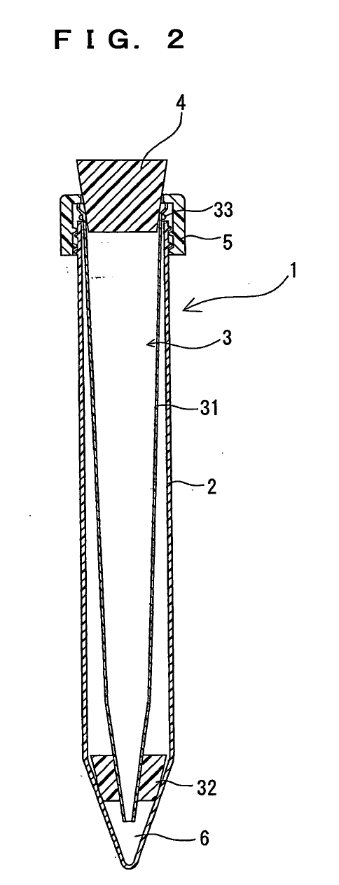

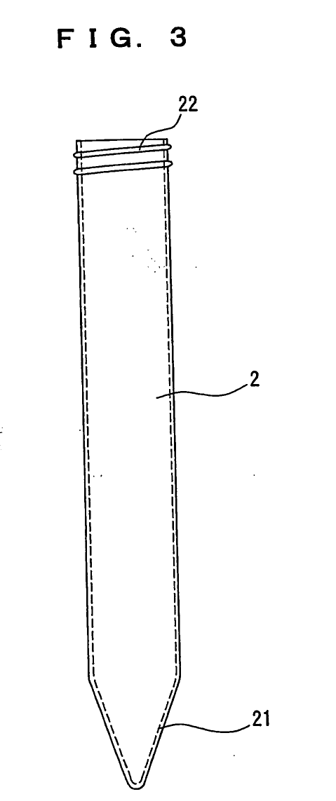

The bottomed tube 2 is a cylindrical member whose distal end is closed and proximal end is open. As shown in FIGS. 1, 2, and 3, the diameter of a distal portion 21 decreases gradually toward its distal end. As shown in the drawings, it is preferable that the diameter of the distal portion 21 decreases taperingly.

As the material of the bottomed tube 2, hard resin or semi-hard resin is preferable. It is particularly desirable that the material has transparency to such an extent that the inside of the bottomed tube 2 can be seen therethrough.

Specifically, as the material of the bottomed tube 2, it is preferable to use polyolefins such as polypropylene, polyethylene, and the like; styrene resins such as polystyrene, SBS, and the like; polyester resins such as polyethylene terephthalate, polybutylene terephthalate, and the like; acrylonitrile resins, polyvinyl chloride; PMMA (polymethyl methacrylate), and the like.

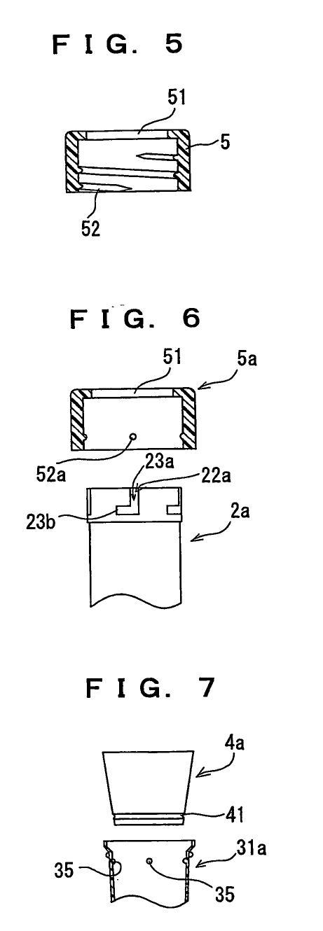

The fixing member 5 for removably fixing the inner tube 3 to the bottomed tube 2 is a short cylindrical member, as shown in FIGS. 1, 2, and 5, and has an opening 51 allowing insertion of the sealing member 4 thereinto.

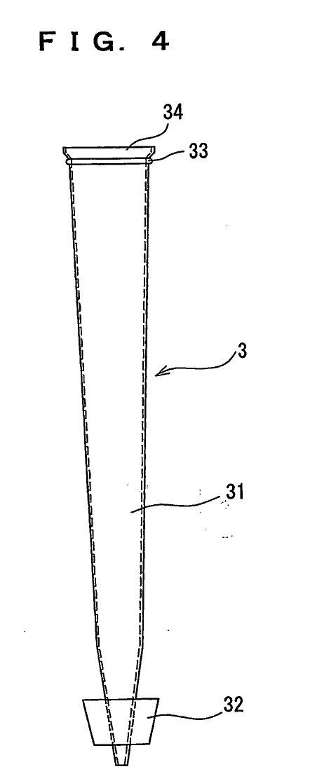

It is preferable that the bottomed tube 2 and the fixing member 5 have a removable engaging portion respectively. In the centrifuging settling tube shown in FIGS. 1 through 5, an engaging portion which engages the fixing member 5 is formed on an outer surface of an opening of the bottomed tube 2. Particularly, in the centrifuging settling tube shown in FIGS. 1 through 5, a proximal portion of the bottomed tube 2 has a first screwing portion 22, and the fixing member 5 has a second screwing portion 52 capable of screwing the first screwing portion 22. The mode of the engagement between the bottomed tube 2 and the fixing member 5 is not limited to the above-described screwing mode. For example, as shown in FIG. 6, a fixing member 5a may have a projection 52a which is a second engaging portion, and the proximal portion of a bottomed tube 2a may have a concave portion 22a which is an engaging portion capable of engaging the projection 52a which is the second engaging portion. The engaging portion 22a has a guide groove 23a for guiding the projection 52a and an engaging groove 23a for preventing removal of the projection 52a. In this engaging mode, the projection may be formed on the bottomed tube, and the groove may be formed on the fixing member.

As the material of the fixing member 5, semi-hard resin or soft resin is preferable. Specifically, it is preferable to use polyolefins such as polypropylene, polyethylene, and the like; a polyolefin elastomer; styrene resins such as polystyrene, SBS, and the like; polyester resins such as polyethylene terephthalate, polybutylene terephthalate, and the like; a polyester elastomer or the like.

The inner tube 3 is constituted of the tube body 31 that is insertable into the bottomed tube 2 and open at distal and proximal ends thereof and of the ring-like elastic member 32 provided on the outer surface of the distal portion of the tube body 31.

The tube body 31 is cylindrical. As shown in FIGS. 1, 2 and 4, the diameter of the tube body 31 gradually decreases toward the distal end thereof. Particularly, as shown in the drawings, it is preferable that the diameter gradually decreases taperingly. The diameter of the main body also gradually decreases taperingly. A diameter-increased portion having a diameter larger than the inner diameter of the proximal end of the bottomed tube is formed at the proximal end of the tube body 31 to prevent the inner tube from being completely accommodated inside the bottomed tube. The length of a portion of the tube body 31 that can be inserted into the bottomed tube is set to a length that does not reach the inner surface of the distal end of the bottomed tube.

As the material of the tube body 31, hard resin or semi-hard resin is preferable. It is particularly desirable that the material has transparency to such an extent that the inside of the tube body 31 can be seen therethrough. Specifically, as the material of the tube body 31, it is preferable to use polyolefins such as polypropylene, polyethylene, and the like; styrene resins such as polystyrene, SBS, and the like; polyester resins such as polyethylene terephthalate, polybutylene terephthalate, and the like; acrylonitrile resins, polyvinyl chloride; PMMA (polymethyl methacrylate) and the like.

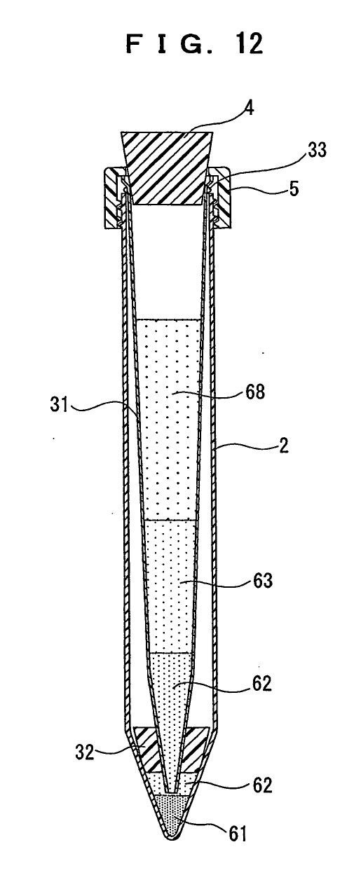

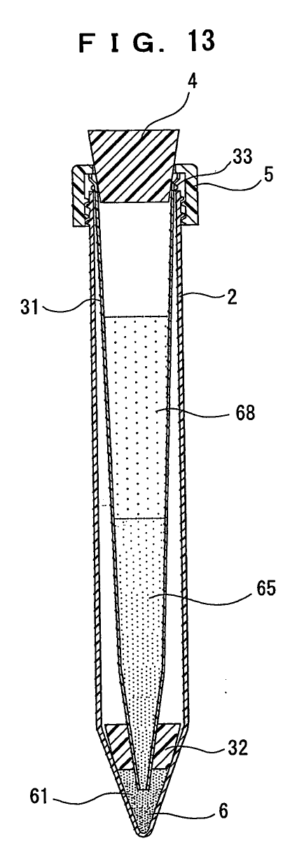

The ring-like elastic member 32 is fixed to the outer surface of the distal portion of the tube body 31 and is capable of closely contacting the inner surface of the distal portion of the bottomed tube 2 At least the period of time in which centrifugal separation is carried out the ring-like elastic member 32 is capable of liquid-tightly holding the space between the inner surface of the bottomed tube 2 and the outer surface of the distal portion of the tube body 31. Therefore the ring-like elastic member 32 is made of an elastic material. To facilitate the insertion of the inner tube 3 into the bottomed tube 2 and reduce the volume of the collecting portion 6 formed in the space formed by the surface of the distal end of the ring-like elastic member 32, the inner surface of the distal portion of the bottomed tube 2, and the outer surface of the distal portion of the inner tube 3, the ring-like elastic member 32 is mounted on the distal portion of the tube body 31 whose diameter decreases taperingly, and the maximum outer diameter of the ring-like elastic member 32 is set smaller than the inner diameter of the main body (equal-diameter portion) of the bottomed tube 2. To ensure close contact between the ring-like elastic member and the inner surface of the tapered distal portion of the bottomed tube, the outer diameter decreases taperingly. The cone angle of the ring-like elastic member 32 is set smaller than the cone angle of the bottomed tube. Therefore the elastic member 32 securely closely contacts the inner surface of the bottomed tube at the distal portion thereof. When the centrifugal separation is carried out, the inner tube (elastic member) is pressed toward the distal end of the bottomed tube. Thus the elastic member 32 securely closely contacts the inner surface of the bottomed tube 2, thus preventing a liquid to be separated centrifugally from penetrating into the space inside the bottomed tube 2 at the side rearward from the elastic member 32. The ring-like elastic member 32 is fixed to the tube body 31 with an adhesive agent or the like. The mode of the ring-like elastic member 32 is not limited to the above-described mode, but like an elastic member 32b of an embodiment shown in FIG. 10, the ring-like elastic member may have an annular groove 34 on the side surface thereof. Further like an embodiment shown in FIG. 11, the ring-like elastic member may be composed of a plurality of disk-shaped elastic members 32a, 32b.

As the material for forming the ring-like elastic member 32, it is possible to preferably use synthetic rubber including a thermoplastic elastomer such as silicone rubber, isoprene rubber, butadiene rubber, styrene-butadiene rubber, butyl rubber, olefin elastomers, amide elastomers; styrene elastomers or synthetic resin elastomers; natural rubber such as latex and the like. The elastic member 32 is not limited to the one formed separately from the tube body 31, but the elastic member may be formed integrally with the tube body 31 by two-color molding. Alternatively the elastic member 32 can be formed integrally with the tube body 31 by insert molding method of inserting the elastic member formed in advance into a die. When the inner tube is formed by using the above-described two-color molding or insert molding, it is preferable that the material of the tube body and the material of the elastic member are adhesive.

As shown in FIGS. 1, 2, and 4, it is preferable that the inner tube 3 has an O-ring 33 for hermetically sealing the space between the proximal portion of the inner tube 3 and the proximal portion of the bottomed tube 2. In the settling tube 1 of this embodiment, the O-ring 33 is provided at the distal end of the diameter-increased portion 34 formed at the proximal end of the tube body 31. Owing to the fixing member 5, the O-ring 33 is disposed between the diameter-increased portion 34 of the tube body and the opening disposed at the proximal end of the bottomed tube 2, with the O-ring 33 sandwiched between the tube body and the bottomed tube. As the material of the Wring, the materials-for the above-described ring-like elastic member 32 are preferably used.

The settling tube 1 has the collecting portion 6 formed in the space formed by the surface of the distal end of the ring-like elastic member 32, the inner surface of the distal portion of the bottomed tube 2, and the outer surface of the distal portion of the inner tube 3. In a state in which the inner tube 3 is inserted into the bottomed tube 2, and the ring-like elastic member 32 is in contact with the inner surface of the distal portion of the bottomed tube 2, the proximal portion of the inner tube 3 is not in contact with the proximal end of the bottomed tube 2. That is, a clearance is provided between the proximal portion of the inner tube 3 and the proximal end of the bottomed tube 2. Therefore by a centrifugal force generated when the centrifugal separation is performed, the inner tube 3 is allowed to move a little toward the distal end of the bottomed tube 2. Therefore by utilizing the centrifugal force generated when the centrifugal separation is performed, close contact between the ring-like elastic member 32 and the bottomed tube 2 is ensured.

The sealing member 4 removably seals the opening formed at the proximal end of the inner tube 3. In the centrifugal settling tube 1 of this embodiment, the sealing member 4 is a plug, made of an elastic member, which decreases taperingly in its diameter. The outer diameter of the distal portion is smaller than the inner diameter of the open portion 51 of the fixing member 5 and the inner diameter of the open portion of the tube body 31 disposed at the proximal end thereof. Therefore the distal portion of the sealing member 4 is inserted into the inner tube 3 from the fixing member and capable of sealing the proximal end of the inner tube. Like an embodiment shown in FIG. 7, the proximal portion of a sealing member 4a and that of the inner tube (tube body 31a) may have an engaging means respectively for preventing a sealing member 4a from being removed from the proximal portion of the inner tube (proximal portion of tube body 31a). In the embodiment shown in FIG. 7, an engaging projection 35 is formed on the inner surface of the proximal portion of the inner tube (tube body 31a), and a groove 41 capable of engaging the engaging projection 35 is formed on the outer surface of the distal portion of the sealing member 4a. In this engaging mode, the projection may be formed on the sealing member, and the groove may be formed on the inner tube (tube body). As the material for the sealing member, the above-described materials for the ring-like elastic member 32 are preferably used.

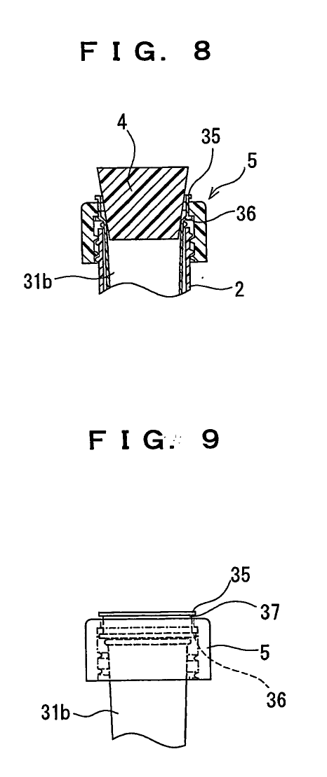

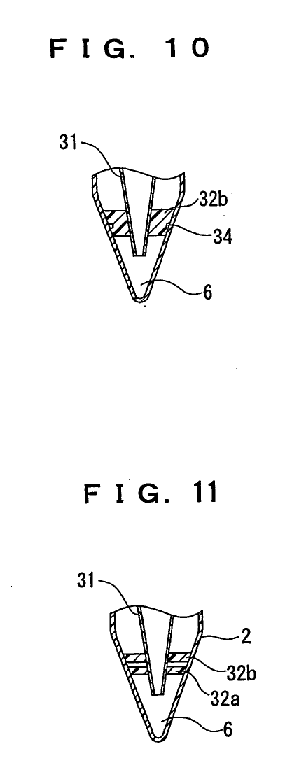

Like embodiments shown in FIGS. 8 and 9, the fixing member 5 may have an engaging portion engaging the inner tube 3 when the fixing member 5 is removed from the bottomed tube 2. Thus when the fixing member 5 is separated from the bottomed tube, the inner tube 3 can be taken out of the bottomed tube 2. This construction facilitates an operation of taking out the inner tube 3 from the bottomed tube 2. In the settling tube of the embodiments shown in FIGS. 8 and 9, the fixing member 5 is mounted on the inner tube 3. By removing the fixing member 5 from the bottomed tube 2, the inner tube 3 can be taken out of the bottomed tube 2. In the settling tube of this embodiment, the proximal end of the inner tube (tube body 31) projects outward from the opening disposed at the proximal end of the fixing member 5, and at a portion of the tube body 31b projected outward from the fixing member 5, an engaging portion 35 which contacts the outer surface of the periphery of the open portion of the fixing member 5 is formed. It preferable that the engaging portion 35 is formed as an annular rib or a flange, but it is possible to form one rib or a plurality of ribs which project from the side surface of the tube body 31b. In a state in which the fixing member 5 is mounted on the bottomed tube 2, the engaging portion 35 of the tube body 31b and the outer surface of the proximal end of the fixing member 5 are spaced at a short interval (clearance is provided therebetween), and the proximal portion of the inner tube 3 is not in contact with the proximal end of the bottomed tube 2. Therefore by the centrifugal force generated when the centrifugal separation is performed, the inner tube 3 is allowed to move a little toward the distal end of the bottomed tube 2 Therefore by utilizing the centrifugal force when the centrifugal separation is performed, close contact between the ring-like elastic member 32 and the bottomed tube 2 is ensured. In the settling tube of this embodiment, at a portion of the tube body 31b disposing the inner side of the fixing member 5 thereof, an engaging portion 36 which contacts the periphery of the inner surface of the open portion of the fixing member 5 is formed. It is preferable that the engaging portion 36 is formed as an annular rib or a flange, but it is possible to form one rib or a plurality of ribs that project from the side surface of the tube body 31b. The fixing member 5 is mounted on a cylindrical portion 37 disposed between the engaging portions 35 and 36. The outer diameter of the cylindrical portion 37 is set a little larger than the inner diameter of the open portion of the fixing member 5. Therefore an operation of mounting the fixing member 5 on the bottomed tube 2 is not obstructed, and without rotating the inner tube in the mounting operation, the fixing member can be mounted on the bottomed tube.

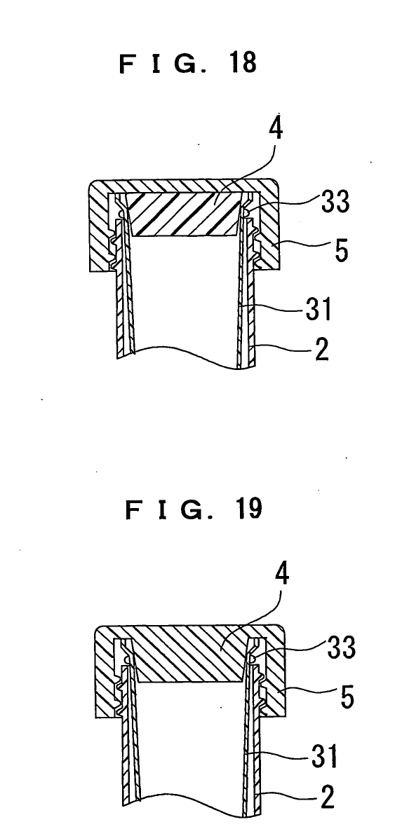

As shown in FIG. 18, the fixing member 5 may have a closed surface, and the sealing member 4 may be fixed to the inner surface of the closed surface. The sealing member 4 can be fixed to the fixing member 5 with an adhesive agent or the like. As shown in FIG. 19, the fixing member 5 and the sealing member 4 may be integrally formed. In this case, the fixing member 5 and the sealing member 4 may be made of the same material and integrally formed or may be integrally formed by two-color molding by using different materials.

It-is preferable that the centrifugal settling tube 1 is used to remove viruses or bacteria from a liquid containing organic cells. More specifically, the centrifuging settling tube removes viruses or bacteria from the liquid containing the organic cells. By centrifuging, the centrifugal settling tube keeps the viruses or the bacteria inside the inner tube 3 without flowing them into the collecting portion 6 of the bottomed tube and is capable of collecting the organic cells inside the collecting portion 6 of the bottomed tube 2.

The organic cells are spermatozoa or ova. Viruses or bacteria include one or more of herpes virus, papilloma virus, molluscum contagiosum virus, hepatitis virus, human acquired immunodeficiency virus, cytomegalovirus, EB virus, Chlamydia, trachomatis, gonococcus, treponema pallidum, chancroid bacterium, and Candida.

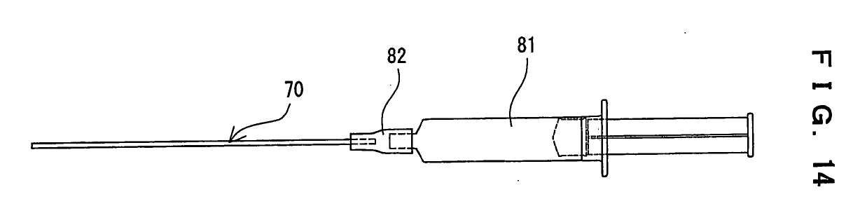

In the centrifugal settling tube 1, a liquid for use in centrifugal separation may be filled in the distal portion of the bottomed tube 2 and in the distal portion of the inner tube. As the liquid, for example, a percoll liquid, a saline solution, and the like can be used. It is preferable that the liquid contains a medium and that the concentration of the medium is high in the distal portion of the bottomed tube and low in the inner tube. When the concentration of the medium is differentiated in this manner, as shown in FIG. 12, the concentration thereof is set high at the distal side and low at the proximal side or as shown in FIG. 13, the concentration thereof is set stepwise or successively low from the distal side toward the proximal side.

By using FIG. 12, the method of using the centrifuging settling tube of the present invention is described below.

In the description made below, a case where a liquid containing spermatozoa from which the HIV has been removed is collected from semen collected from a positive HIV person is exemplified.

A semen-diluted liquid obtained by diluting collected semen by means of a liquid substrate, for example, an HTF liquid substrate or an HTF liquid substrate containing 10% SSS (Serum Substitute Supplement) is prepared. The centrifugal settling tube 1 is prepared, the sealing member is removed. A percoll liquid (modified silica gel-containing liquid) is injected from the distal end of the bottomed tube. Thereby the collecting portion formed at the distal portion of the bottomed tube and at least the distal portion (preferably, middle portion of inner tube) of the inner tube are filled with the liquid. The percoll liquid is sequentially injected to form a layer 61 whose concentration is 90%, a layer 62 whose concentration is 60%, and layer 63 whose concentration is 30%. The semen-diluted liquid 68 prepared in the above-described manner is injected over the layer 63 whose concentration is 30%. Thereafter the inner tube is sealed with the sealing member. As shown in FIG. 13, the percoll liquid may be injected in such a way that the layer 61 whose concentration is 90% is formed at the distal side and that a successive concentration gradient layer 65 is formed in which the concentration changes to 30% stepwise or successively. Such a concentration gradient can be formed by using a successive gradient formation apparatus. The settling tube prepared in this manner is set to a centrifugal separator to perform centrifugal separation. It is preferable that the centrifugal separation is performed, for example, at about 3000 rpm for about 25 minutes. After the centrifugal separation finishes, the fixing member is taken out from the bottomed tube, and the inner tube is pulled out from the bottomed tube. Thereby inside the bottomed tube, a spermatozoa-containing liquid not substantially containing the HIV is obtained.

The organic cell collection tube of the present invention will be described below by using embodiments.

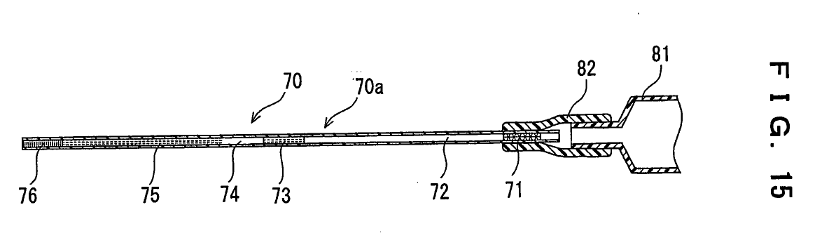

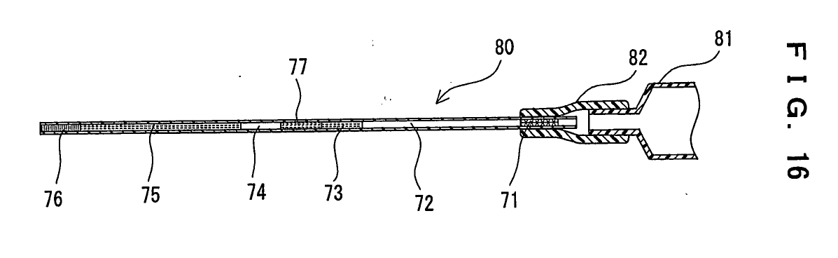

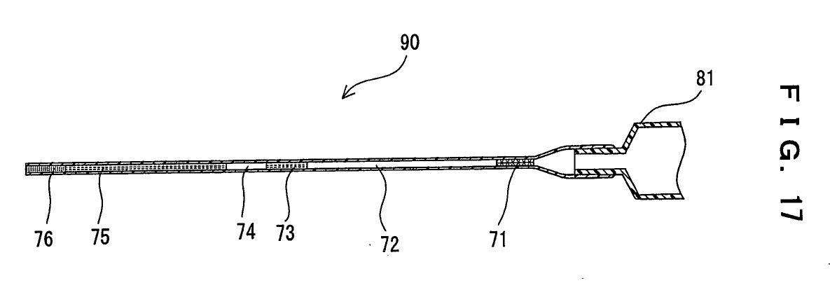

FIG. 14 is an outlook view of the organic cell collection tube of the present invention on which a suction appliance is mounted. FIG. 15 is a sectional view of an organic cell collection tube according to one embodiment of the present invention. FIG. 16 is a sectional view of an organic cell collection tube according to another embodiment of the present invention. FIG. 17 is a sectional view of an organic cell collection tube according to another embodiment of the present invention.

An organic cell collection tube 70 of the present invention removes viruses or bacteria from a liquid containing organic cells and collect the organic cells. The organic cell collection tube 70 has a tube 70a having a path penetrating therethrough from one to other ends thereof; a sealing member layer 71, accommodated in the tube 70a, which contacts a moisture content and is thereby capable of substantially forming a liquid-tight state; a first aqueous liquid layer 73 which is filled in at a position nearer to one end of the tube 70a than the sealing member layer 71 and spaced at a predetermined interval from the sealing member layer 71; a first air layer 72 provided between the first aqueous liquid layer 73 and the sealing member layer 71; a second aqueous liquid layer 75 filled in at a position spaced at a predetermined interval from the first aqueous liquid layer 73; a second air layer 74 provided between the second aqueous liquid layer 75 and the first aqueous liquid layer 73; and a viscous substance-containing liquid layer 76 which is provided in contact with the second aqueous liquid layer 75 and captures viruses or bacteria disposed at one end portion of the tube.

It is preferable that the organic cell collection tube has a liquid suction appliance connection connector 82 at its other end. The other end of the body cell collection tube may be formed as a portion which can be connected to a liquid suction appliance. It is preferable that the organic cell collection tube has a liquid suction appliance 81 connected to the other end thereof directly or through the connector 82.

The organic cells to be collected by the organic cell collection tube 70 of the present invention include spermatozoa and ova. Viruses and bacteria to be captured by the viscous substance-containing liquid layer 76 includes at least one of herpes virus, papilloma virus, molluscum contagiosum virus, hepatitis virus, human acquired immunodeficiency virus, cytomegalovirus, EB virus, Chlamydia, Chlamydia trachomatis, gonococcus, treponema pallidum, chancroid bacterium, and Candida.

As the tube 70a, any tubes can be used, provided that they have a path penetrating through the tube 70a from one end thereof to the other end thereof. It is preferable that the tube 70a has a cylindrical portion which has almost the same inner diameter and is extended in a predetermined length. It is preferable that the inner diameter of the tube is 1 mm to 5 mm and that the length thereof is 50 to 200 mm.

It is preferable that the tube 70a has transparency to such an extent that the inside thereof can be seen therethrough and is made of a material which can be heat-sealed. As the material of the tube 70a, thermoplastic resins such as polyesters (for example, polyethylene terephthalate, polybutylene terephthalate); polyolefins (for example, polyethylene, ultra-high-molecular-weight polyethylene, polypropylene, ethylene-propylene copolymer, ethylene-vinyl chloride copolymer); styrene resins (for example, polystyrene, methacrylate-styrene copolymer, methacrylate-butylene-styrene copolymer); polyamides (for example, nylon 6, nylon 66), and the like are used. The tube 70a may be composed of multi-layered resin. As the inner layer of the tube, resins having high heat-sealing performance are preferable. For example, low molecular weight polyethylene and especially unstretchable low molecular weight polyethylene are preferable. The above-described inner layer may be formed at only a portion to be heat-sealed. As the outer layer of the tube, the above-described thermoplastic resins and resins such as fluororesin, polyimide, and the like which are difficult to be heat-sealed may be used. As the fluororesins, it is possible to use polytetrafluoroethylene, an ethylene-tetrafluoroethylene copolymer, a tetrafluoroethylene-hexafluoropropylene copolymer, and chlorotrifluoroethylene resin, As the polyimide, aromatic polyimide is preferable. The substance composing the outer layer may be drawn uniaxially or biaxially.

The sealing member layer 71 is a layer which contacts the moisture content and is thereby capable of substantially forming the liquid-tight state. The sealing member layer can be made of, for example, an air-permeable member containing a water-swollen substance. As the air-permeable member, it is possible to use fibrous materials such as cotton thread, silk thread, and ?; filter materials, and the like. As the water-swollen substance, known substances are used. When the water-swollen substance composing the sealing member layer is dry, the sealing member layer is air-permeable. When the water-swollen substance is in a swelled state, the sealing member layer substantially closes the path inside the tube, thus displaying air-tightness. As the water-swollen substance, for example, it is possible to use natural polymeric substances such as karaya gum, gum Arbic, gum tragacanth and the like; synthetic or semi-synthetic polymeric substances such as sodium alginate, sodium carboxymethylcellulose, metal salts of polyacrylate, polyethylene oxide, polyvinyl pyrrolidone, salts and acids of copolymer of alkylvinyl ether and maleic anhydride; acrylic substance-starch graft polymers containing hydrolyzed substances such as starch-acrylonitrile, starch-acrylic acid, starch-acrylic amide, starch-sodium acrylate, and the like; partly saponified polyvinyl alcohol, salts of polyacrylic acid; acrylic acid-vinyl alcohol polymers; polyethylene oxide; cellulose polymers, and the like. The content of the water-swollen substance of the sealing member layer 71 is favorably 5 to 60% and more favorably 15 to 50%.

The first aqueous liquid layer 73 is formed nearer to the one-end of the tube 70a than the sealing member layer 71, with the first aqueous liquid layer 73 spaced at the predetermined interval from the sealing member layer 71. As the first aqueous liquid layer 73, any liquids containing a moisture content such as pure water, refined water, a saline solution, a liquid substrate, and the like can be used. It is preferable that the same aqueous liquid as that used for the second aqueous liquid layer 75 or approximate thereto is used as the first aqueous liquid layer 73. When the to-be-collected liquid containing organic cells is sucked to the tube 70, the first aqueous liquid layer moves to the sealing member layer sequentially. Thus the second aqueous liquid layer 75 passes the portion where the first aqueous liquid layer has been positioned. Therefore when the first aqueous liquid is the same as the second aqueous liquid or approximate thereto, there is little possibility that the property of the aqueous liquid constituting the second aqueous liquid layer is changed. The first aqueous liquid layer may contain female hormone. As the female hormone, it is preferable to use at least one selected from among the group of pregnanediol, estrone (E1), estradiol (E2), estriol (E3), estetrol (E4), and progesterone.

The first air layer 72 is formed between the sealing member layer 71 and the first aqueous liquid layer 73. Sterile air is filled inside the first air layer 72 The volume of the first air layer 72 is set to almost-the same amount as that of the to-be-collected liquid containing organic cells to be sucked to the tube 70 or a littler larger than that.

The second aqueous liquid layer 75 is a portion for collecting the organic cells to be collected and filled with a liquid for keeping cells active. As such a liquid, for example, liquids suitable for cells to be collected, for example, a liquid substrate, physiological saline, and the like are used. For example, when spermatozoa are collected, the HTF liquid substrate and the HTF liquid substrate containing SSS (Serum Substitute Supplement) are preferable. When the HTF liquid substrate contains the SSS, its concentration is preferably 5 to 15%. As the HTF liquid substrate containing the SSS, Complete HTF Medium (commercial name, produced by IS Japan, and containing SSS at 10%) is available. The volume of the second aqueous liquid layer 75, in other words, the filling amount of the second aqueous liquid is set to almost the same amount as that of the to-be-collected liquid containing organic cells to be sucked to the tube 70 or a littler larger than that.

The second air layer 74 is provided between the second aqueous liquid layer 75 and the first aqueous liquid layer 73. Inside the second air layer 74, sterile air is filled. The volume of the second air layer 74 is set to such an extent as to separate the second aqueous liquid layer 75 and the first aqueous liquid layer 73 from each other and may be thus small.

The viscous substance-containing liquid layer 76 is provided in contact with the second aqueous liquid layer 75 and is disposed at one end of the tube. The viscous substance contained in the liquid layer 75 is, for example, a water-soluble viscous polymeric compound. It is preferable that the viscous substance is water-soluble viscous polysaccharides. Particularly, it is preferable that the viscous substance is at least one selected from among the group of glycosamino glycan, glycuronane, methyl cellulose, dextran, pectin, starch, gum Arabic, and guar gum. It is preferable that the glycosamino glycan is at least one selected from among the group of chondroitin sulfate, chondroitin, hyaluronic acid, dermatan sulfate, heparin, heparin sulfate, keratan sulfate, kerato-poly sulfate or salts of these substances or derivatives thereof. It is preferable that the content of the viscous substance in the liquid layer 76 is in the range of 1- 20 mg/ml, although the content of the viscous substance is different according to the viscous substance used. As the solvent constituting the liquid layer, sterile water such as pure water, refined water, and the like is used, but the solvent is not limited thereto. The liquids used for the second aqueous liquid layer may be used as the solvent

Like an organic cell collection tube 80 shown in FIG. 16, the organic cell collection tube of the present invention may have a female hormone-containing layer 77 provided between the first aqueous liquid layer 73 and the first air layer 74. As the female hormone, it is preferable to use at least one selected from among the group of pregnanediol, estrone (E1), estradiol (E2), estriol (E3), estetrol (E4), and progesterone.

Each of the organic cell collection tubes 70, 80 has a liquid suction appliance connection connector 82 at the other end thereof. A liquid suction appliance 81 is connected to the organic cell collection tubes 70 and 80 respectively through the connector 82. The connector 82 has a tube connection end portion at one end thereof, and a suction appliance connection end portion at the other end thereof. More specifically, the connector 82 is made of an elastic material. The inner diameter of the connector 82 at the one end thereof is set a little smaller than the outer diameters of one end of the tubes 70, 80, and the inner diameter of other end of the connector 82 is set a little smaller than the outer diameter of the connection portion of the suction appliance. As the material for forming the connector 82, it is possible to preferably use synthetic rubber including thermoplastic elastomers such as silicone rubber, isoprene rubber, butadiene rubber, styrene-butadiene rubber, butyl rubber, olefin elastomers, amide elastomers, styrene elastomers, and the like or synthetic resin elastomers; and natural rubber such as latex. As the suction appliance 81, a syringe can be preferably used.

Like an organic cell collection tube 90 shown in FIG. 17, the other end of the tube may be formed as a portion which can be connected to the liquid suction appliance. The other end of the tube 90 increases in its diameter, and its inner diameter is set a little smaller than the outer diameter of the connection portion of the suction appliance.

The method of using the organic cell collection tube of the present invention is described below.

In the description made below, the case where the liquid containing spermatozoa from which the HIV has been removed is collected from semen collected from a positive HIV person is exemplified.

The semen-diluted liquid obtained by diluting collected semen by means of the liquid substrate, for example, the HTF liquid substrate or the HTF liquid substrate containing 10% SSS (Serum Substitute Supplement) is prepared. Alternatively a liquid containing spermatozoa collected by using the above-described centrifuging settling tube is prepared. In the case of the seamen-diluted liquid, after the liquid is injected into the bottomed tube, centrifugal separation (for example, 1200 rpm, 10 minutes) is performed to waste a supernatant. Then the liquid substrate is added to a precipitate. In this manner, the spermatozoa-containing liquid is obtained.

The organic cell collection tube 70 having the connector 82 and the suction appliance 81 mounted at the other end thereof is prepared. Then by operating the suction appliance, the spermatozoa-containing liquid prepared in the above-described manner is sucked to the tube 70 from its one end. A sucking operation is finished when a predetermined amount of the spermatozoa-containing liquid is sucked. If the first aqueous liquid 73 has not reached the sealing member layer 71 at this point a predetermined amount of air is sucked so that the aqueous liquid reaches the sealing member layer to seal the sealing member layer.

After the connector and the syringe are removed, the tube is put in a test tube. Thereafter the test tube is swum up, with the test tube inclined at a predetermined angle (for example, about 10 degrees) and the spermatozoa are cultured at 37° C. for 45 minutes. In this state spermatozoa move upward and pass through the viscous substance-containing liquid layer 76. At that time, viruses and bacteria adhering spermatozoa are captured in this layer. The spermatozoa reach the inside of the second aqueous liquid layer 75. The tube is heat-sealed at a position a little proximal from the position of the viscous substance-containing liquid layer 76. The tube is cut at a heat-sealed position. Thereby it is possible to obtain the organic cell-containing liquid from which the viruses and bacteria have been removed. If the first aqueous liquid layer contains female hormone or if a female hormone-containing layer is formed between the first aqueous liquid layer and the first air layer, the spermatozoa move upward actively to a high extent and can be collected securely.

### INDUSTRIAL APPLICABILITY

The centrifuging settling tube of the present invention has a bottomed tube closed at a distal end thereof and open at a proximal end thereof, an inner tube constituted of a tube body that is insertable into the bottomed tube and open at distal end and proximal end thereof and of a ring-like elastic member provided on an outer surface of the distal portion of the tube body, a sealing member capable of sealing a proximal end opening of the inner tube, and a fixing member for removably fixing the inner tube to the bottomed tube. The distal end of the inner tube is spaced at a predetermined interval from a distal end of the bottomed tube, with the inner tube inserted into the bottomed tube. At least during centrifugal separation, the ring-like elastic member is capable of liquid-tightly holding a space between an inner surface of the bottomed tube and the outer surface of the distal portion of the tube body. The settling tube further includes a collecting portion formed in a space formed by a surface of a distal end of the ring-like elastic member, an inner surface of a distal portion of the bottomed tube, and an outer surface of a distal portion of the inner tube.

Therefore after the centrifugal separation finishes, the fixing member is removed from se bottomed tube, and the inner tube is pulled out of the bottomed tube. Thereby it is possible to easily collect the high-specific-gravity substance separated by the-centrifugal separation and collected in the collecting portion of the bottomed tube without the substance collected in the inner tube mixing with the high-specific-gravity substance.

The organic cell collection tube of the present invention removes viruses or bacteria from a liquid containing organic cells and collects the organic cells. The organic cell collection tube has a tube having a path penetrating therethrough from one to other ends thereof, a sealing member layer, accommodated in the tube, which contacts a moisture content and is thereby capable of substantially forming a liquid-tight state, a first aqueous liquid layer which is formed at a position nearer to one end of the tube than the sealing member layer and spaced at a predetermined interval from the sealing member layer, a first air layer provided between the first aqueous liquid layer and the sealing member layer, a second aqueous liquid layer formed at a position spaced at a predetermined interval from the first aqueous liquid layer, a second air layer provided between the second aqueous liquid layer and the first aqueous liquid layer, and a viscous substance-containing liquid layer which is provided in contact with the second aqueous liquid layer and captures viruses or bacteria disposed at one end portion of the tube.

When the organic cells contained in the organic cell-containing liquid sucked from the one end of the organic cell collection tube and collected inside the tube from the other end (viscous substance-containing liquid layer) thereof, move in the viscous substance-containing liquid layer, viruses or bacteria contained therein adhering organic cells captured by the viscous substance-containing liquid layer. Thereafter the organic cell-containing liquid move to the second aqueous liquid layer. Therefore the organic cell collection tube is capable of collecting the organic cell-containing liquid little containing the viruses and the bacteria.

1. A centrifuging settling tube comprising:
a bottomed tube closed at a distal end thereof and open at a proximal end thereof;
an inner tube constituted of a tube body that is insertable into said bottomed tube and open at distal end and proximal ends thereof and of a ring-like elastic member provided on an outer surface of said distal portion of said tube body;
a sealing member capable of sealing a rear end opening of said inner tube; and
a fixing member for removably fixing said inner tube to said bottomed tube,
wherein said distal end of the inner tube is spaced at a predetermined interval from a distal end of said bottomed tube, with the inner tube inserted into said bottomed tube;
at least during centrifugal separation, said ring-like elastic member is capable of liquid-tightly holding a space between an inner surface of said bottomed tube and the outer surface of said distal portion of said tube body,
said settling tube further comprising a collecting portion formed in a space formed by a surface of a distal end of said ring-like elastic member, an inner surface of a distal portion of said bottomed tube, and an outer surface of a distal portion of said inner tube.

2. A centrifuging settling tube according to claim 1, wherein said distal portion of said bottomed tube decreases in a diameter thereof toward said distal end thereof.

3. A centrifuging settling tube according to claim 2, wherein said ring-like elastic member is capable of closely contacting an inner surface of said distal portion of said bottomed tube that decreases in said diameter thereof toward said distal end thereof.

4. A centrifuging settling tube according to claim 1, wherein said distal portion of said tube body decreases in a diameter thereof toward said distal end thereof.

5. A centrifuging settling tube according to claim 1, wherein said ring-like elastic member decreases in a diameter thereof toward said distal end thereof.

6. A centrifuging settling tube according to claim 1, wherein said fixing member has an engaging portion that engages said inner tube when said fixing member is removed from said bottomed tube; and when said fixing member is separated from said bottomed tube, said inner tube can be taken out of said bottomed tube.

7. A centrifuging settling tube according to claim 1, wherein a proximal portion of said bottomed tube has a first screwing portion; and said fixing member has a second screwing portion capable of screwing said first screwing portion.

8. A centrifuging settling tube according to claim 1, wherein said proximal portion of said bottomed tube has a first engaging portion; and said fixing member has a second engaging portion capable of engaging said first engaging portion.

9. A centrifuging settling tube according to claim 1, wherein a proximal portion of said sealing member and that of said inner tube have an engaging means respectively for preventing said sealing member from being removed from said proximal portion of said inner tube.

10. A centrifuging settling tube, according to claim 1, for removing viruses or bacteria from a liquid containing organic cells.

11. A centrifuging settling tube, according to claim 1, for removing viruses or bacteria from a liquid containing organic cells,
wherein by centrifuging said liquid, said centrifugal settling tube keeps said viruses or said bacteria inside said inner tube without flowing said viruses or said bacteria into said collecting portion of said bottomed tube and is capable of collecting said organic cells inside said collecting portion of said bottomed tube.

12. A centrifuging settling tube according to claim 1, wherein a liquid is filled in said distal portion of said bottomed tube and said distal portion of said inner tube.

13. A centrifuging settling tube according to claim 1, wherein said liquid contains a medium; and a concentration of said medium is high in said distal portion of said bottomed tube and low in said inner tube.

14. A centrifuging settling tube according to claim 1, wherein said organic cells are spermatozoa or ova.

15. A centrifuging settling tube according to claim 1, wherein said viruses or bacteria include one or more of herpes virus, papilloma virus, molluscum contagiosum virus, hepatitis virus, human acquired immunodeficiency virus, cytomegalovirus, EB virus, Chlamydia, Chlamydia trachomatis, gonococcus, treponema pallidum, chancroid bacterium, and Candida.

16. A centrifuging settling tube according to claim 1, wherein said sealing member is fixed to said fixing member or said sealing member is formed integrally with said fixing member.

17. An organic cell collection tube for removing viruses or bacteria from a liquid containing organic cells and collecting said organic cells, comprising:
a tube having a path penetrating therethrough from one to other ends thereof;
a sealing member layer, accommodated in said tube, which contacts a moisture content and is thereby capable of substantially forming a liquid-tight state;
a first aqueous liquid layer which is filled in at a position nearer to one end of said tube than said sealing member layer and spaced at a predetermined interval from said sealing member layer;
a first air layer provided between said first aqueous liquid layer and said sealing member layer;
a second aqueous liquid layer filled in at a position spaced at a predetermined interval from said first aqueous liquid layer;
a second air layer provided between said second aqueous liquid layer and said first aqueous liquid layer; and
a viscous substance-containing liquid layer which is provided in contact with said second aqueous liquid layer and captures viruses or bacteria disposed at one end portion of said tube.

18. An organic cell collection tube, according to claim 17, having a liquid suction appliance connection connector at other end thereof.

19. An organic cell collection tube according to claim 17, wherein said other end thereof is formed as a portion which can be connected to a liquid suction appliance.

20. An organic cell collection tube, according to claim 17, having a liquid suction appliance connected to said other end thereof directly or through said connector.

21. An organic cell collection tube according to claim 17, wherein said sealing member layer which contacts said moisture content and is capable of substantially forming a liquid-tight state is made of an air-permeable member containing a water-swollen substance.

22. An organic cell collection tube according to claim 17, wherein a viscous substance contained in said viscous substance-containing liquid layer is a water-soluble viscous polymeric compound.

23. An organic cell collection tube according to claim 17, wherein said viscous substance contained in said viscous substance-containing liquid layer is water-soluble viscous polysaccharides.

24. An organic cell collection tube according to claim 17, wherein said viscous substance contained in said viscous substance-containing liquid layer is at least one selected from among a group of glycosamino glycan, glycuronane, methyl cellulose, dextran, pectin, starch, gum Arabic, and guar gum.

25. An organic cell collection tube according to claim 24, wherein said glycosamino glycan is at least one selected from among a group of chondroitin sulfate, chondroitin, hyaluronic acid, dermatan sulfate, heparin, heparan sulfate, keratan sulfate, kerato-poly sulfate or salts thereof or derivatives thereof.

26. An organic cell collection tube according to claim 17, wherein said organic cells are spermatozoa or ova.

27. An organic cell collection tube according to claim 17, wherein said viruses or bacteria include one or more of herpes virus, papilloma virus, molluscum contagiosum virus, hepatitis virus, human acquired immunodeficiency virus, cytomegalovirus, EB virus, Chlamydia, Chlamydia trachomatis, gonococcus, treponema pallidum, chancroid bacterium, and Candida.

28. An organic cell collection tube according to claim 17, wherein said first aqueous liquid layer contains female hormones.

29. An organic cell collection tube, according to claim 17, having a female hormone-containing layer provided between said first aqueous liquid layer and said first air layer.
